(19) United States
(12) Patent Application Publication
(10) Pub. No.: US 2007/0009300 A1
(43) Pub. Date: Jan. 11, 2007

(54) Use text fields for adding text to tab labels of tab stock inserted into copy jobs

(75) Inventors: Bryon R. Young, Pittsford, NY (US); Paul F. Brown II, Webster, NY (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: XEROX CORPORATION

(21) Appl. No.: 11/167,424

(22) Filed: Jun. 27, 2005

(51) Int. Cl. B41J 11/44

(52) U.S. Cl. 400/76

(57) ABSTRACT

A method and system for printing tab information on tab stock inserted into a print job output. A tab programming window is displayed on a tab programming screen of a user interface for receiving user-inputted data and information. Tab label data, tab label data orientation information, and tab stock size information is inputted by the user for at least one sheet of tab stock to be inserted into the print job output. The received tab label data is printed on a label portion of a corresponding inserted tab sheet in accordance with the received tab label data orientation information.

### INCORPORATION BY REFERENCE

U.S. Pat. No. 5,133,048 to Parsons, et al. describes a procedure for providing ordered tab stock, the disclosure of which is incorporated herein by reference in its entirety.

### BACKGROUND

The invention relates to electronic printers and printing systems, and more particularly, to a system for printing text on precut tabs of ordered tab stock.

Reprographic systems and other printing systems are intended to provide the operator or user with as many features and job programming options and selections as reasonably possible. One common programming option is choice of stock, i.e. the print media on which the prints are made. Some stock types are preordered, such as, e.g. sheets sequentially colored in different colors. One desirable preordered stock type is precut tabs. However, when using precut tab stock, a difficulty arises with respect to printing on the label portion of the tab stock as sheets of the tab stock are inserted into the printed output document.

U.S. Pat. No. 5,133,048 to Parsons, et al. deals with the problem of making sure that the image being printed matches up with the correct tab and that this remains so during the entire printing process. However, a difficulty remains with respect to entering information to be printed on the label portion of the tab stock. The user normally makes originals with printed data in locations corresponding to each tab label. The originals can be prepared on standard size paper, however, this requires shifting the printed data when printing on the tab stock which is an oversize stock because the label portion of the stock extends beyond the standard size stock dimensions. Images of the scanned originals are then transferred to the tab stock label by one of several methods, each of which is cumbersome and labor intensive. For example, in one method, the user prints the tab pages as a separate job, shifting the images if necessary, and then inserts the printed tab pages into the output document as preprinted tab pages, either manually or by carefully programming insertion of the preprinted tab pages.

In another method, the user combines the preprinted tab originals into the original input document set and then programs the tab stock as a special stock, again including an image shift to shift the printed portion onto the label portion of the tab stock in the printed output document. This is, like the first method, time consuming, and error prone if the user inadvertently programs the image shift for the preprinted tab stock and subsequently forgets to remove the shift for the following input job segment. The problem is exacerbated if the input the print job is a duplex job, which is most common for jobs involving tab stock inserts. In this case, the user switches between duplex mode, for the input document, and simplex mode, for the preprinted tab stock, making the process even more error prone and difficult.

The present application provides an improved method for adding text to the label portion of tab stock, making the process more user friendly and less error prone.

### BRIEF DESCRIPTION

According to aspects illustrated herein, there is provided a method for printing tab information on tab stock inserted into a print job output. The method includes displaying a tab programming window on a tab programming screen of a user interface for receiving user-inputted data and information. The user inputs tab label data for at least one sheet of tab stock to be inserted into the print job output, tab label data orientation information, and tab stock size information. The received tab label data is printed on a label portion of a corresponding inserted tab sheet in accordance with the received tab label data orientation information.

According to further aspects illustrated herein, there is also provided a second method for printing tab information on tab stock inserted into a print job output. The second method includes scanning an input document segment comprising a portion of the input document, storing the scanned input segment in a memory, and selectively performing a tab insert process. The tab insert process includes displaying a tab programming window on a tab programming screen of a user interface for receiving user-inputted data and information, and receiving tab label data inputted by the user for at least one sheet of tab stock to be inserted into the print job output. Also received is tab label data orientation information and tab stock size information inputted by the user. A tab stock sheet image is inserted into the memory following the stored scanned input segment, including the received tab label data on a label portion of the tab stock sheet image in accordance with the received tab label data orientation information. The scanning an input document segment, the storing the scanned input segment, and the selectively performing a tab insert process are repeated for the remaining input document segments. The stored job segments and the inserted tab stock images are then printed.

According to still further aspects illustrated herein, there is provided printing system including an input section, a user interface, a multi-function finisher, a main memory, and a system controller. The input section includes a scanning system for scanning documents to be processed by the printing system, and the system controller includes program logic. The program logic is configured to display a tab programming window on a tab programming screen of a user interface for receiving user-inputted data and information, receive tab label data inputted by the user for at least one sheet of tab stock to be inserted into the print job output, receive tab label data orientation information inputted by the user, receive tab stock size information inputted by the user, and print the received tab label data on a label portion of a corresponding inserted tab sheet in accordance with the received tab label data orientation information.

### BRIEF DESCRIPTION OF THE DRAWINGS

FIG. 1 is an illustration of a reprographic machine suitable for incorporating concepts of the present application;

FIG. 2 is a block diagram depicting major components of the reprographic machine shown in FIG. 1;

FIG. 3 is a representation of a Build Job programming screen as shown on the User Interface of the reprographic machine shown in FIG. 1;

FIG. 4 is a representation of a Build Job image editing screen as shown on the User Interface of the reprographic machine shown in FIG. 1;

FIG. 5 is a representation of a Build Job tabs programming screen as shown on the User Interface of the reprographic machine shown in FIG. 1;

FIG. 6 is a representation of a Non-Build Job insert programming screen as shown on the User Interface of the reprographic machine shown in FIG. 1; and

FIG. 7 is flow diagram of a method according to the present application.

### DETAILED DESCRIPTION

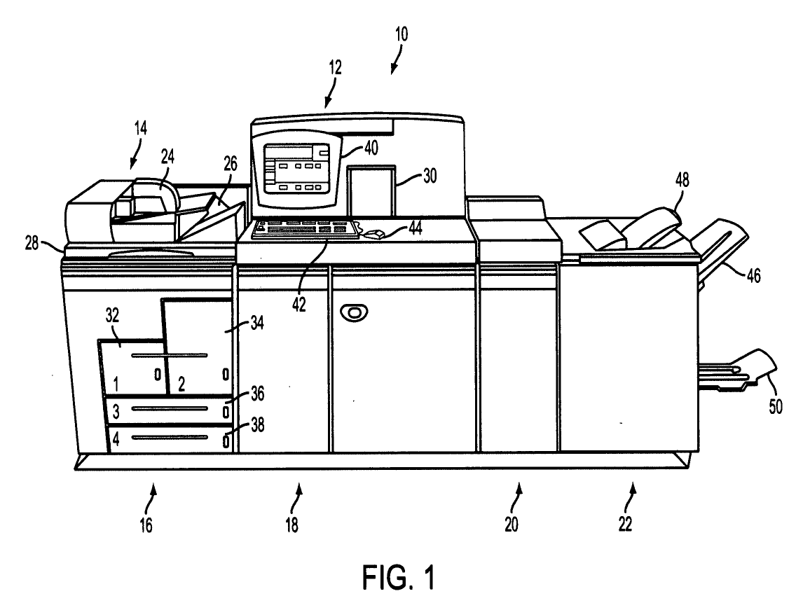

With reference to FIG. 1, there is shown an exemplary image printing system 10 for processing print jobs in accordance with the teachings of the present application. The word “printer” and the phrase “printing system” as used herein encompass any apparatus such as a digital copier, bookmaking machine, facsimile machine, multi-function machine, etc. which performs a print outputting function for any purpose. The printing system 10, for purposes of explanation, is generally divided into a user interface 12, an input section 14, a feed module 16, an image/output terminal (IOT) 18, a multi-function finisher interface 20, and a multi-function finisher (MFF) 22. The input section 14 further includes a document input tray 24, a document exit tray 26, and a scanning system 28 for receiving documents which are to be scanned and processed by the printing system 10.

Input to be processed by the printing system 10, in some embodiments, may be received from a media drive bay 30 which can accept document submissions in the form of files from a variety of media such as, e.g., DVD-RAM, DVD-ROM, DVD-R, CD-R, CD-RW, CD-DA, CD-ROM/XA, CD-ROM, CD-I, CD-EXTRA, CD-TEXT, and VIDEO-CD formats. Document or file submissions to the printing system 10 may also be received by means of a network connection (not shown). The feed module 16 may include a number of paper or substrate trays 32-38, each of which is normally used to supply a substrate for use by the printing system 10. For example, the first substrate tray 32 may be used for providing tab stock to the printing system 10 for inserting tabs into the printed output document. The main substrate tray 34 is normally used to supply the most commonly used paper, such as 8½×11 letter sized stock. The third and fourth substrate trays 36, 38 may be used to supply alternate sizes of paper or printable stock.

The user interface 12 normally includes a display screen 40, a keyboard 42, and a pointing device 44 which enables a user at the user interface 12 to interface with the printing system 10 for inputting commands to the printing system, viewing the current status of various components of the printing system, and observing informational messages displayed on the display screen 40. The display screen 40, in some embodiments, may be a touch screen to further facilitate a user friendly interface with the printing system 10. The multi-function finisher 22 includes a main tray stacker 46 for receiving printed documents, and may optionally include a top tray 48 and a lower tray 50. The multi-function finisher 22 is typically configured to perform a variety of functions, such as folding documents, making booklets, stapling bindings, and collating documents, in addition to the normal stacking of output.

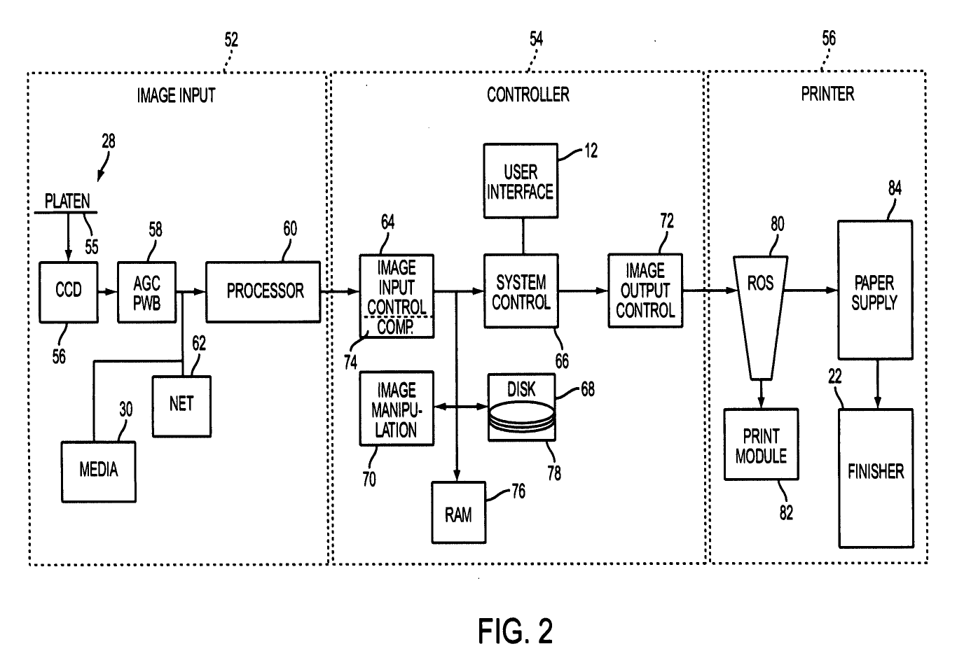

With reference now to FIG. 2 and continuing reference to FIG. 1, the printing system 10 may be conceptually and functionally grouped according to the arrangement shown in the figure. For example, the printing system 10 essentially comprises an image input section 52, a controller section 54, and a printer section 56. For scanning of image input, the input section 52 includes, as part of the scanner 28, a transparent platen 55 on which documents to be scanned are located. One or more linear arrays 56 are provided for reciprocating scanning movement below the transparent platen 55. A lens system and a mirror system (not shown) cooperate to focus the linear array 56 on a line-like segment of the platen 55 and the document being scanned thereon. Image data is generated by means of an automatic gain control (AGC) printed wiring board (PWB) 58 and inputted into a processor 60. After processing by the processor 60, the image signals are outputted to the controller section 54. As previously described, the processor 60 may receive image input from a network connection 62 or from media in the media drive bay 30.

The controller section 54 includes an input image controller 64, the user interface 12, a system controller 66, a main memory 68, an image manipulation section 70, and an image output controller 72. Data received from the processor 60 by the controller section 54 is compressed by an image compressor/processor 74. Image data passed through the compressor/processor 74 is normally segmented into slices N scan lines wide, each slice having a slice pointer. The compressed image data, together with slice pointers and any related image descriptive data providing image specific information (such as height and width of the document in pixels, the compression method used, pointers to the compressed image data, and pointers to the image slice pointers, etc.) are placed in an image file. The image files, which represent different copy/print jobs, are temporarily stored in a system memory 76 which usually comprises a random access memory (RAM) pending transfer to the main memory 68 where the data is held pending use. The main memory 68 may include one or more hard discs 78 for additionally storing machine operating system software, machine operating data, and the scanned image data currently being processed.

The printer section 56 includes a raster output scanner (ROS) 80, a print module section 82, a paper supply section 84, including the previously described paper trays 32-38, and the multi-function finisher 22. The ROS 80 is configured with a laser source for providing an imaging beam to transfer images received from the image output controller 72 to a photoreceptor included in the print module 82. Developed images on the photoreceptor are then transferred and permanently fixed by a fuser to a substrate provided from any of the paper trays 32-38. The finisher 22 then provides any selected finishing functions to the processed substrate such as stitching or stapling as previously described.

For the purpose of providing a full appreciation of advantages of concepts of the present application, a typical prior art procedure for inserting printed tab stock into the output of a document copy job is now described. Build Job is a procedure provided on the printing system 10 that is used to combine multiple document scans, each scan having different job programming, into a single combined output. For example, Build Job allows you to scan different types of documents either from the document input tray 24, or directly from the platen, in the scanning system 28 in separate segments and then combine those separate scan segments into one cohesive output document. For this reason, Build Job is often used to insert printed tab stock into the output where each tab is considered as a separate job segment.

Basically, the user scans a first job segment and then scans a printed sheet having desired tab stock text preprinted on the sheet as a following job segment. However, because the scanned sheet is typically smaller than the tab stock because the tab stock includes an extended tab label portion, the user must remember to select an option to shift the printing on the scanned sheet in order to move the printed output onto the label portion of the tab stock. For example, when scanning 8½ by 11 documents and inserting tab sheets which, including the tab label portion, are 9×11 inches, the user typically scans a preprinted sheet of 8½ by 11 paper having appropriate tab text on it and then selects an option to shift that scanned image ½ inch in the direction of the label portion in order to move the desired text onto the tab label portion of the output tab sheet.

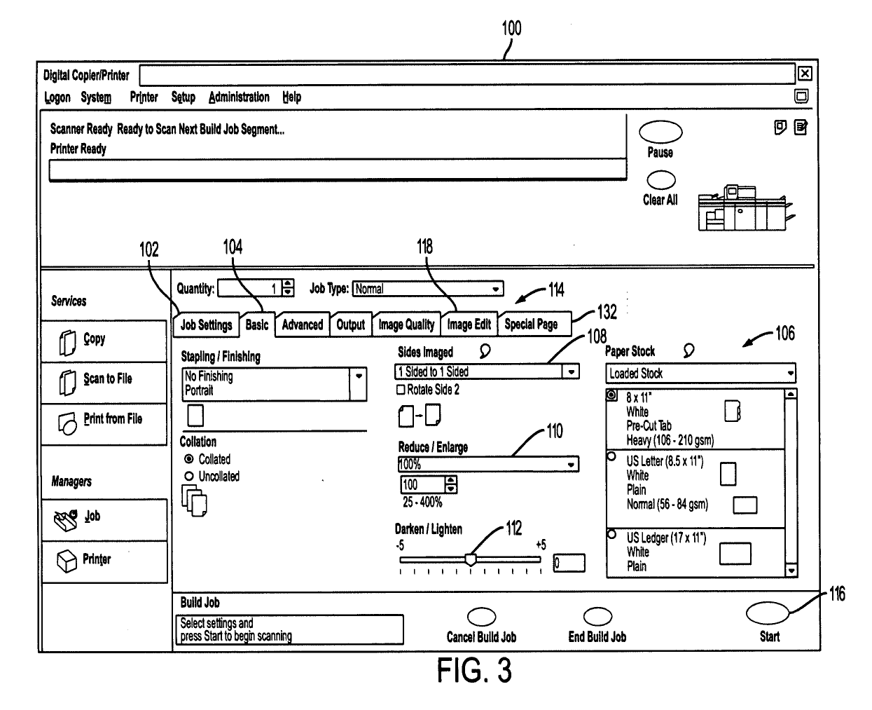

With reference now to FIG. 3, the Build Job procedure is described in more detail. The user first selects a Build Job option shown on the display screen 40 and may also optionally select a type of job indicating that the copy job being generated contains tab stock. After making this selection, a Build Job screen 100 as shown in the figure is presented to the user. In a first preparatory step for the job, the user normally first selects a Job Settings tab 102 and performs job level programming which is applicable to the entire copy job. Such job level programming may include, for example, page numbering, front covers, annotation, stapling or finishing options, collation options, and other options.

When the user has programmed all of the necessary job level settings, other tabs in the Build Job screen 100 become active enabling the user to perform segment level programming for the first segment. For example, as shown in the figure, a Basic tab is active enabling the user to select job segment parameters such as paper attributes as provided in a Paper Stock window 106, sides to be imaged as provided in a Sides Imaged menu 108, reduction or enlargement options as provided in a Reduce/Enlarge menu 110, and other image adjustments such as the one provided by a Darken/Lighten slider 112. It is to be appreciated that there may be a large number of additional segment level programming options selected under additional segment level tabs 114, however, a detailed description of these is not necessary for an understanding of the present application.

When the user has completed the segment level programming, a start button, or icon, 116 is selected to initiate scanning of the job segment at the input section 14 of the printing system 10. After the user has completed scanning the first job segment, the user places a printed sheet having the correct tab information at the input section 14. Typically, if the tab stock provided in one of the paper trays 32-38 is 9×11 inches overall, for example, the sheet placed in the input section 14 will have printing along one edge of an 8½×11 sheet of paper, at least in the correct position for the label portion of the corresponding tab sheet in the input tray, except shifted to fit within the confines of the 8½×11 sheet. In order to save time and to reduce the number of errors, the sheet placed in the input section 14 may have printing along one edge corresponding to all possible tab label positions. For example, if the user is using five-cut tab stock, i.e., tab stock that has five different tab label positions, the printed sheet may have appropriate text for each of the five tab label positions. Of course, the preprinted text on the sheet must be correctly oriented or rotated in order to print correctly on the label portion of the tab stock. Normally, a 90 degree counter-clockwise rotation is appropriate to put the text in alignment with the tabs.

The user can now select the Basic tab 104 to perform segment level programming for the current tab segment sheet in the input section 14. Importantly, the Sides Imaged menu 108 should be adjusted to show one-sided to one-sided regardless of the type of copying being performed for the remainder of the copy job. That is to say, even if the document being copied is being copied in a duplex mode, two-sided to two-sided, or even one-sided to two-sided, the tab segment portion of the job must be treated as a one-sided to one-sided segment. Also importantly, the paper stock pull down menu 106 must be adjusted to indicate that 9×11 precut tab stock is being selected from one of the paper trays 32-28 of the feed module 16 for the current tab segment.

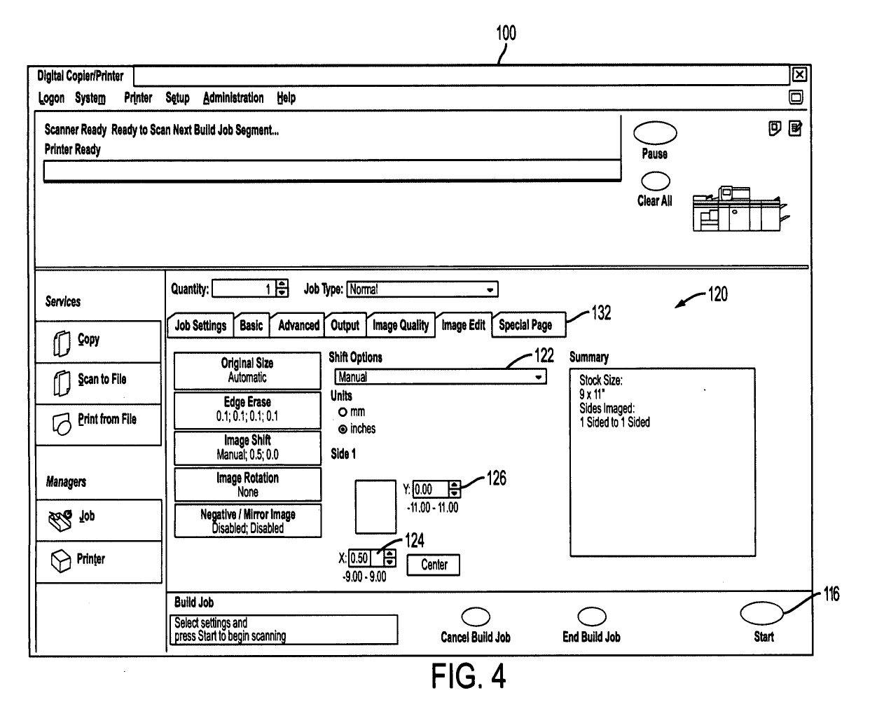

Also importantly, the user must remember now to select the Image Edit tab 118 which brings up an image edit screen 120 as shown in FIG. 4. The user then selects a manual shift option in a Shift Options menu 122, and enters an appropriate shift amount in either an X shift window 124 or Y shift window 126 as appropriate. For normal tab stock being printed in a portrait orientation with tabs on the right hand side, the user typically enters a ½ inch X shift in the X shift window 124. When this has been accomplished, the user selects the start button 116 to copy the tab sheet provided in input section 14 and shift the scanned information the specified amount as indicated in the shift windows of the image edit screen 120.

Each remaining document segment to be copied is now processed by the user at the printing system 10 in the same fashion as the first document segment and the first tab segment described above. However, the possibility of making an error or mistake during this process is readily apparent. For example, at the beginning of each document segment, because the user has changed the Basic Tab 104 settings and the Image Edit 118 tab settings to correspond to tab stock, the user must remember at the beginning of each document segment to return to the Basic Tab 104 programming screen and reprogram the segment to correspond to the upcoming input document. This includes remembering to reprogram the Sides Imaged menu if it is other than one-sided to one-sided and, importantly, the Loaded Stock menu 106 must be adjusted to conform to the current document segment being scanned. Also, importantly, but easy to overlook, the user must remove any shift amounts provided for the tab stock in the Image Edit screen 120 in order to avoid erroneously shifting the input document images. Any error introduced during these programming steps is very difficult, if not impossible, to correct after a segment has been scanned. Thus, it is readily apparent why an improved method of providing textual information for printing on tab stock as provided by the current application is very beneficial.

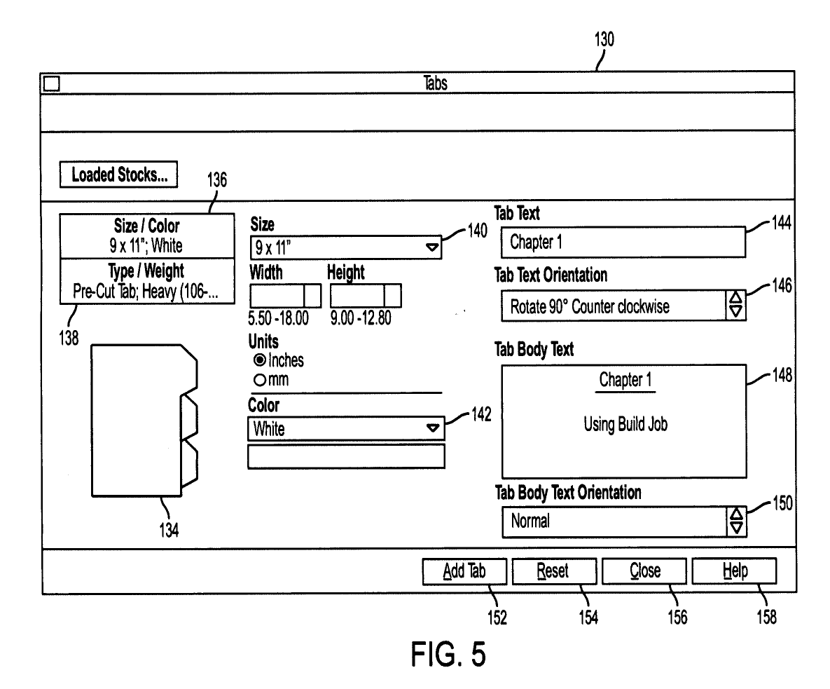

With reference now to FIG. 5, and continuing reference to FIG. 4, in one embodiment, either before or after a Build Job segment has been scanned, the user may navigate to a Build Job Tabs window 130 by means of the Special Page tab 132, or other tab optionally programmed into the system. The Build Job Tabs window 130 places the programmed tab into the document stream immediately after the current segment images. By placing the programmed tabs into the document stream in this manner, the user is relieved from any necessity to count and specify in advance after which page the programmed tab is to be inserted, which would be very error prone. The Build Job Tabs window 130 includes a graphic 134 indicating that tab stock is the currently selected stock. A summary description is provided in a Size/Color window 136, and a summary of the type of paper stock is provided in the Type/Weight window 138. The user may change the currently selected size of tab stock by means of a tab stock Size selection window 140. The user may also change additional options for the tab stock, for example, by means of a tab stock Color selection window 142.

Having now entered the various specifications regarding the tab stock to be inserted into the document stream, the user may now enter appropriate textual information to be printed on the inserted tab. In a Tab Text window 144, the user may enter specific text to be printed on the tab label portion of the tab stock. Although, in the particular example shown, the user has entered specific text, namely, “Chapter 1,” it is to be appreciated that various automatic text generation symbols may be entered into the tab text window 144. For example, as is known in the art, a pound symbol (#) can be used to represent an automatically incrementing number for sequentially numbered tab inserts. Features such as this further reduce the likelihood for errors by eliminating the necessity of manually remembering to enter an appropriate number for each tab. Further, because the tab insert function knows which tab label position is in the appropriate paper feed tray, the possibility of printing in the inter page gap area is greatly reduced. For example, U.S. Pat. No. 5,133,048 to Parsons, et al. describes a procedure for providing ordered tab stock which maintains produced prints in correct sequence with tabbed stock. However, in prior art implementations, a user might prepare a tab image having textural information in all of the available tab label positions in order to reduce the user's work load. In doing this, however, for each sheet of tab stock inserted into the job stream, printing in the inter page gap area would occur, thereby undesirably depositing toner on the imaging drum in an area where it must be later removed.

A further advantage provided by the Build Job Tabs window 130 is the retention of entered information from a previous tab insert. For example, the text entered into the tab text window 144 may optionally remain from one tab insert to the next, whereby the user only changes information appropriate to the current tab label, such as the chapter number in the example shown. The user is also provided with a Tab Text Orientation window 146 for specifying an orientation of the text to be printed in the tab label area. In the example shown, the normal orientation is rotated 90 degrees counter-clockwise so that the text prints parallel to the narrow dimension of the tab label. Any number of tab text orientations may be provided in the orientation window 146 such as, e.g., printing the text in a vertical orientation from top to bottom on the respective tab label.

Optionally, the user may provide text to print in the body of the tab stock by using Tab Body Text window 148. Because the body text prints in a larger area than the label portion, Tab Body Text window 148 may optionally include automatic wrapping of the text within predetermined margin settings. Other formatting options normal to printing text may also be included, such as the ability to underline, italicize, or to select various fonts, for example. A Tab Body Text Orientation window 150 is provided so that the user may specify an orientation of the tab body text in a manner similar to the above-described Tab Text Orientation window 146.

When the user has reviewed the information entered on the Build Job Tabs window 130 and is satisfied that it is correct, an Add Tab function 152 may be selected to insert the respective tab sheet into the document stream at the end of the current Build Job segment since no insertion location is specified in the Build Job Tabs feature window 130 as previously described. On the other hand, the user may select a Reset function 154 to restore each of the windows in the Build Job Tabs window 130 to their original default status in order to reenter the appropriate tab information, or to start programming for a different format of tab. A Close function 156 is provided so that the user may close the Build Job Tabs window 130 and return to the main Build Job window 100 as shown in FIG. 3. A Help function 158 may optionally be provided by which the user may access further instructions regarding any of the features provided in the Build Job Tabs window 130.

It should be readily apparent that there is a significant advantage to be gained by entering tab textual information according to the procedure described with reference to FIG. 5, when compared to the prior art method described previously. For example, in the prior art method, many of the parameters provided in the Build Job screen 100 of FIG. 3 were necessarily altered to conform to the appropriate tab stock provided in the corresponding paper tray. This included, in many cases, changing the Sides Imaged selection window 108 to indicate a one-sided to one-sided reprographic operation even though the document being scanned may have required a two-sided to two-sided operation or another operation other than one-sided to one-sided. The Paper Stock window 106 was also necessarily changed to indicate an appropriate paper size and type for the tab stock.

Each time the user inserted a tab into the document stream, the user had to necessarily remember each of the parameters changed in the Build Job screen 100 and restore those parameters to their correct settings for the document being scanned. This introduced a great likelihood for error in the scanning process. On the other hand, the procedure described with respect to the present application eliminates or greatly reduces this possibility for error. When the user has successfully entered a new tab into the document stream by means of the Add Tab function 152 and closes the Build Job Tabs window 130 by means of the Close function 156, all of the previously entered document and option settings in the Build Job window 100 of FIG. 3 have retained their originally specified values, thereby relieving the user of any necessity of reentering that information. Further, the information entered in the Build Job Tabs window 130 may be retained by the system so that when the user reactivates the Build Job Tabs window 130 by means of the Special Page tab 132, the system may be configured to retain information from the previously inserted tab sheet, thereby simplifying the process for each succeeding tab sheet to be inserted.

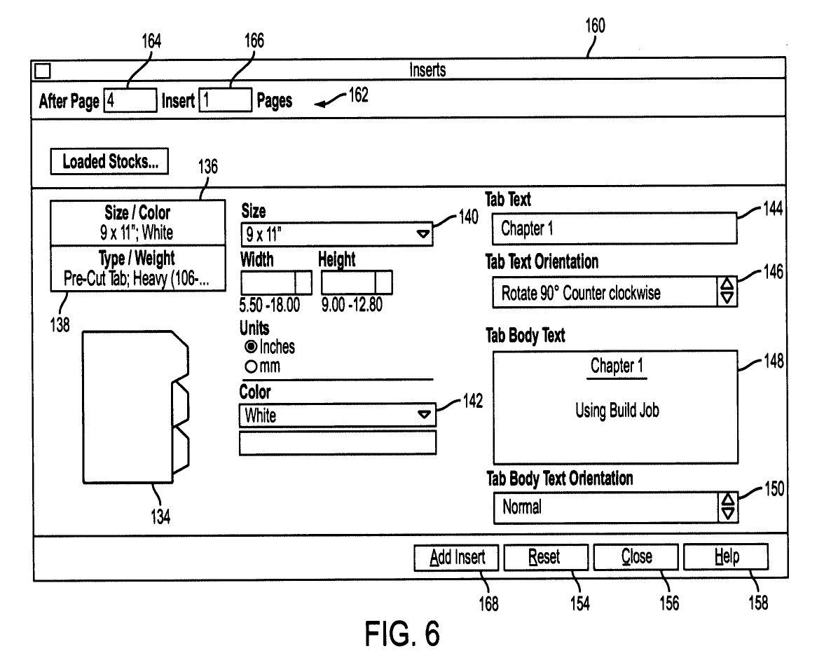

According to another embodiment of the present application, tab pages having user-inputted textual information to be printed on them may be inserted without using the Build Job procedure described with reference to FIGS. 3-5. Instead, prior to processing a copy job, the user may navigate to an Inserts window 160 as shown in FIG. 6. Like numerals have been used in FIG. 6 for like elements common to tab programming features as described with reference to FIG. 5. A difference between the Tabs window 130 and the Inserts window 160 lies in the fact that Inserts window 160 is programmed before the copy job, in its entirety, is scanned and printed. For this reason, a page programming area 162 is provided in the Inserts window 160 for populating the document stream position for each inserted tab. In the page programming area, an After Page window 164 is provided for entering a page number, or a plurality of page numbers, after which a tab page is to be printed and inserted into the output. A Pages window 166 is also provided to specify a number of pages to be inserted although, normally, only one printed tab page is inserted after each of the pages specified in After Page window 164. After preparing tab text and/or tab body text by means of the tab text and tab body text programming windows 144-150, as previously described, the user may specify insertion of these tab sheets into the copy job by selecting an Add Insert function 168. After doing this, the user may program additional tab sheets into the copy job by programming new page information in the page programming area 162 and adjusting any tab text or tab body text programming in the corresponding programming areas 144-150.

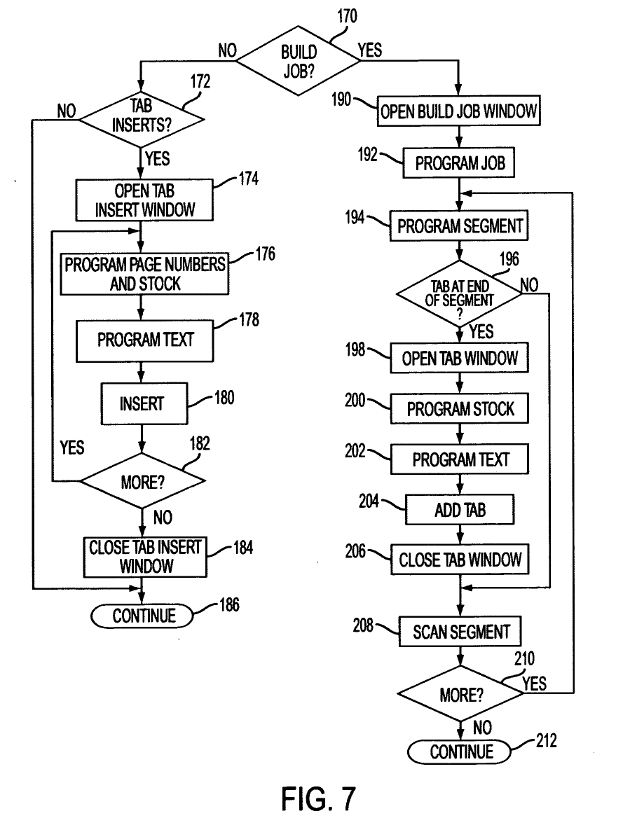

With reference now to FIG. 7, a method according to the above-described procedures of the present application is summarized. It is to be appreciated that, in the flow chart of FIG. 7, only general descriptions of the steps are provided because these were described in more detail hereinbefore with reference to FIGS. 3-6. According to this method, at step 170, it is first determined from the user whether or not to perform a Build Job. If not, the system then determines from the user at step 172 whether any tab sheet inserts are to be programmed. When the response is in the affirmative at step 174, a tab insert programming window is opened and, at step 176, the user programs page number and stock information as previously described with reference to the Inserts window 160. Additionally, at step 178, the user programs tab text information and tab body text information, and following this request, the tab insert function at step 180. At step 182, if the user needs to insert additional tab sheets into the copy job, processing returns to step 176 for additional programming. When all of the tab sheets have been programmed for insertion, as necessary, at step 184, the tab insert window is closed and normal processing of the copy job continues at step 186. Previously, at step 172, if it was determined that no tab sheet inserts were necessary for the copy job, the above-described processing step would have been skipped and processing would also continue at step 186.

If, however, it was determined at step 170 that a Build Job process is to be performed, the system opens the Build Job Tabs window 130 at step 190. The user then programs any required job programming information at step 192, and then programs the first and additional job segments at step 194. For each segment, at step 196, it is determined if a tab is to be inserted. If so, a tab programming window is opened at step 198, the appropriate tab stock is programmed at step 200, and appropriate tab text and tab body text, as previously described, is programmed at step 202. Following this, the user indicates that a tab is to be added to the job being built at step 204, and the tab programming window is closed at step 206. Subsequently, the current segment is scanned at step 208. Similarly, if it was determined at step 196 that no tab insertion is necessary for this job segment, processing would continue at step 208 for scanning the current segment. At step 210, a determination is made as to whether more job segments are to be processed or scanned and, if more segments are to be scanned, processing returns to step 194 for segment programming. Otherwise, normal Build Job processing continues at step 212.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for printing tab information on tab stock inserted into a print job output in a printing system including an input section for receiving electronic document pages to be processed by the printing system as part of the print job output, the method comprising:
displaying a tab programming window on a tab programming screen of a user interface for receiving user-inputted data and information;
receiving tab label data inputted by the user for at least one sheet of tab stock to be inserted into the print job output;
receiving tab label data orientation information inputted by the user;
receiving tab stock size information inputted by the user; and
printing the received tab label data on a label portion of a corresponding inserted tab sheet in accordance with the received tab label data orientation information.

2. The method of claim 1, the receiving tab label data comprising receiving tab label text inputted by the user.

3. The method of claim 1, the receiving tab label data orientation information comprising:
receiving a tab label data rotation amount and direction;
receiving tab label data position information;
rotating the tab label data in accordance with the received tab label data rotation amount and direction; and
positioning the tab label data in accordance with the received tab label data position information.

4. The method of claim 1, further comprising:
receiving tab body data inputted by the user for at least one sheet of tab stock to be inserted into the print job output;
receiving tab body data orientation information inputted by the user; and
printing the received tab body data on a body portion of the corresponding inserted tab sheet in accordance with the received tab body data orientation information.

5. The method of claim 4, the receiving tab body data comprising receiving tab body text inputted by the user.

6. The method of claim 4, the receiving tab body data orientation information comprising:
receiving a tab body data rotation amount and direction;
receiving tab body data position information;
rotating the tab body data in accordance with the received tab body data rotation amount and direction; and
positioning the tab body data in accordance with the received tab body data position information.

7. The method of claim 1, further comprising receiving a page number for the at least one sheet of tab stock to be inserted into the print job output, the page number indicating one of the page before which the tab stock is to be inserted or the page after which the tab stock is to be inserted.

8. The method of claim 1, further comprising:
performing a Build Job process prior to printing the job output, the Build Job process comprising:
scanning on a scanning system included in the input section an input document segment comprising a portion of the input document;
storing the scanned input segment in a memory;
selectively performing the displaying a tab programming window, the receiving tab label data, the receiving tab label data orientation information, the receiving tab stock size information for a sheet of tab stock to be inserted after the input document segment in the output job;
selectively inserting a tab stock sheet image into the memory following the stored scanned input segment, including the received tab label data on a label portion of the tab stock sheet image in accordance with the received tab label data orientation information;
repeating the scanning an input document segment, the storing the scanned input segment, and the selectively performing, for the remaining input document segments; and
printing the stored job segments and the inserted tab stock images.

9. A method for printing tab information on tab stock inserted into a print job output in a printing system including a scanning system for receiving electronic document pages to be processed by the printing system as part of the print job output, the method comprising:
scanning an input document segment comprising a portion of the input document;
storing the scanned input segment in a memory;
selectively performing a tab insert process, the process comprising:
displaying a tab programming window on a tab programming screen of a user interface for receiving user-inputted data and information;
receiving tab label data inputted by the user for at least one sheet of tab stock to be inserted into the print job output;
receiving tab label data orientation information inputted by the user;
receiving tab stock size information inputted by the user; and
inserting a tab stock sheet image into the memory following the stored scanned input segment, including the received tab label data on a label portion of the tab stock sheet image in accordance with the received tab label data orientation information;
repeating the scanning an input document segment, the storing the scanned input segment, and the selectively performing a tab insert process, for the remaining input document segments; and
printing the stored job segments and the inserted tab stock images.

10. The method of claim 9, the receiving tab label data comprising receiving tab label text inputted by the user.

11. The method of claim 9, the receiving tab label data orientation information comprising:
receiving a tab label data rotation amount and direction;
receiving tab label data position information;
rotating the tab label data in accordance with the received tab label data rotation amount and direction; and
positioning the tab label data in accordance with the received tab label data position information.

12. The method of claim 9, tab insert process further comprising:
receiving tab body data inputted by the user for at least one sheet of tab stock to be inserted into the print job output;
receiving tab body data orientation information inputted by the user; and
printing the received tab body data on a body portion of a corresponding inserted tab sheet in accordance with the received tab body data orientation information.

13. The method of claim 12, the receiving tab body data comprising receiving tab body text inputted by the user.

14. The method of claim 12, the receiving tab body data orientation information comprising:
receiving a tab body data rotation amount and direction;
receiving tab body data position information;
rotating the tab body data in accordance with the received tab body data rotation amount and direction; and
positioning the tab body data in accordance with the received tab body data position information.

15. A printing system, the printing system comprising:
an input section including a scanning system for scanning documents to be processed by the printing system;
a user interface;
a multi-function finisher;
a main memory; and
a system controller, the system controller including program logic configured to:
display a tab programming window on a tab programming screen of a user interface for receiving user-inputted data and information;
receive tab label data inputted by the user for at least one sheet of tab stock to be inserted into the print job output;
receive tab label data orientation information inputted by the user;
receive tab stock size information inputted by the user; and
print the received tab label data on a label portion of a corresponding inserted tab sheet in accordance with the received tab label data orientation information.

16. The printing system of claim 15, the program logic further configured to:
receive a tab label data rotation amount and direction;
receive tab label data position information;
rotate the tab label data in accordance with the received tab label data rotation amount and direction; and
position the tab label data in accordance with the received tab label data position information.

17. The printing system of claim 15, the program logic further configured to:
receive tab body data inputted by the user for at least one sheet of tab stock to be inserted into the print job output;
receive tab body data orientation information inputted by the user; and
print the received tab body data on a body portion of the corresponding inserted tab sheet in accordance with the received tab body data orientation information.

18. The printing system of claim 17, the program logic further configured to:
receive a tab body data rotation amount and direction;
receive tab body data position information;
rotate the tab body data in accordance with the received tab body data rotation amount and direction; and
position the tab body data in accordance with the received tab body data position information.

19. The printing system of claim 15, the program logic further configured to receive a page number for the at least one sheet of tab stock to be inserted into the print job output, the page number indicating one of the page before which the tab stock is to be inserted or the page after which the tab stock is to be inserted.

20. The printing system of claim 15, the program logic further configured to:
perform a Build Job process prior to printing the job output, the Build Job process including:
scanning an input document segment comprising a portion of the input document;
storing the scanned input segment in a memory;
selectively performing the displaying a tab programming window, the receiving tab label data, the receiving tab label data orientation information, the receiving tab stock size information for a sheet of tab stock to be inserted after the input document segment in the output job;
selectively inserting a tab stock sheet image into the memory following the stored scanned input segment, including the received tab label data on a label portion of the tab stock sheet image in accordance with the received tab label data orientation information;
repeating the scanning an input document segment, the storing the scanned input segment, and the selectively performing, for the remaining input document segments; and
printing the stored job segments and the inserted tab stock images.
